(19) United States
(12) Patent Application Publication
(10) Pub. No.: US 2009/0190334 A1
(43) Pub. Date: Jul. 30, 2009

(54) ANIMATED LIGHT WITH DYNAMIC ORNAMENTAL EFFECT

(76) Inventor: Alan Yang, Taoyuan City (TW)

Correspondence Address: RABIN & CHAMPAGNE, P. C., Suite 500, 1101 14th Street, N.W., Washington, DC, 20005, US

(21) Appl. No.: 12/020,803

(22) Filed: Jan. 28, 2008

(51) Int. Cl. F21S 6/00

(52) U.S. Cl. 362/124

(57) ABSTRACT

An animated light with dynamic ornamental effects is composed of a lamp holder attached by a lampshade to form a basic structure, a flicker flame bulb installed on the lamp holder, and one or more projection objects having proper shapes and transparent colors that are settled between the flicker flame bulb and the lampshade. Thereupon, when the light is lighted, the flicker of the flicker flame bulb can project the projection objects to a surface of the lampshade in a vivid and dynamic form so that present animated and dynamic images can be presented according to the shapes and colors of the projection objects so as to provide novel and entertaining ornamental effects that contribute to festival atmosphere.

### BACKGROUND OF THE INVENTION

1. Technical Field

The present relates to an animated light with dynamic ornamental effects and, more particularly, to a lighting device composed of a lamp holder attached by a lampshade to form a basic structure, a flicker flame bulb installed on the lamp holder, and one or more projection objects having proper shapes and transparent colors that are settled between the flicker flame bulb and the lampshade such that the flickering property of the lighted flicker flame bulb can project the shape of the projection objects to a surface of the lampshade in a vivid and dynamic manner so as to present animated images that not only have entertaining and aesthetic effects, but also help to create a relevant atmosphere in occasions of festivals.

2. Description of Related Art

Lights cannot only perform a basic function of illumination, but also can provide effects of embellishing environments and harmonizing atmosphere. Therefore, the appearances of lights have been developed with various styles, some of which are superior in patterns while some others of which are predominant in ingenious lightness variations. The development in lights is nowadays rising and prosperous. A light is typically constructed form a lamp holder, a bulb and a lampshade. Therein, the bulb is installed on the lamp holder, and when lighted, transmits a light beam outward through the lampshade so that the light can provide spatial illumination in virtue of the light beam transmitted outside the lampshade or present desired aesthetic effects with the help of patterns painted or printed on the surface of the lampshade. However, even some beauteous patterns are painted or printed on the surface of the lampshade, the resultant images projected by the lighted bulb can nevertheless perform motionless ornamental effects that may be adequate in view of esthetics but fail to provide vividness. In another case where a flicker bulb is used, the flickering light can merely enable patterns on the surface of the lampshade to be present with changeable lightness. Such resultant images are still static and motionless and lack for vividness.

### SUMMARY OF THE INVENTION

In view of the shortcoming of the conventional light that only static and motionless lighting effects can be presented due to a conventional structural design, after implementing his experience accumulated in his years of researching and producing lights as well as careful deliberation and numerous experiments, the inventor of the present invention has successively developed an “animated light with dynamic ornamental effects” that properly integrates a flicker flame bulb, projection objects, and a lampshade on a lamp holder. In such animated light, by the flicker and twinkle of the lighted flicker flame bulb inside the lampshade, images of the projection objects can be projected to a surface of the lampshade in a dynamic form so a to present vivid and animated ornamental effects. Consequently, the light that has enhanced ornamental benefits is more competent for catering to festivals and is contributive to creating atmosphere.

### BRIEF DESCRIPTION OF THE DRAWINGS

The invention as well as a preferred mode of use, further objectives and advantages thereof, will best be understood by reference to the following detailed description of an illustrative embodiment when read in conjunction with the accompanying drawings, wherein:

FIG. 1 is an explode view of a desk light, which is provided as one embodiment of the present invention;

FIG. 2 is an assembled view of the embodiment of the present invention;

FIG. 3 is an applied view of the desk light showing that dynamic images are presented;

FIG. 4 is an assembled view of a wall lamp, which is provided as another embodiment of the present invention;

FIG. 5 is an applied view of the wall lamp showing that dynamic images are presented; and

FIG. 6 provides an embodiment of a projection object of the present invention formed as a tube with patterns printed on a surface thereof.

### DETAILED DESCRIPTION OF THE PREFERRED EMBODIMENT

The structure and effects of the present invention will be described in detail through some preferred embodiments in company with the above-mentioned drawings.

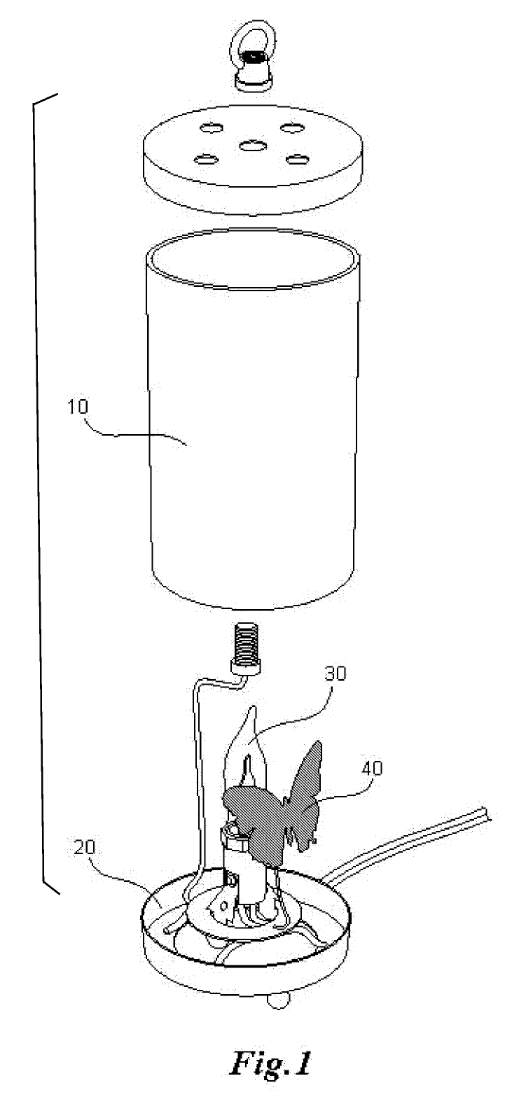

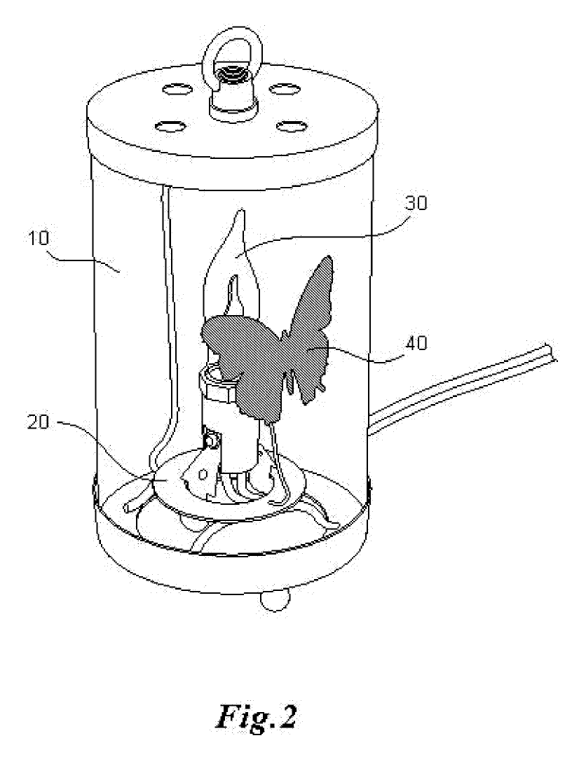

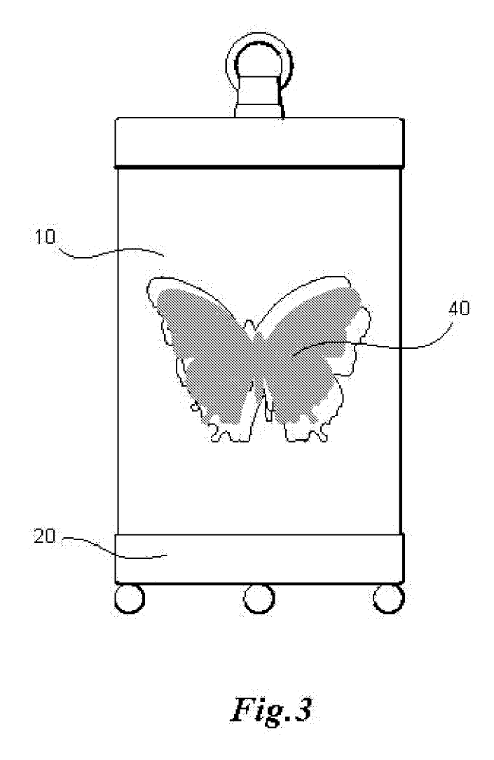

The present invention provides a light comprising a lamp holder 20 attached by a lampshade 10 to form a basic structure and may be embodied as various lighting devices such as desk lights, stand lights, wall lamps and so on. Please refer to FIGS. 1 and 2, wherein one embodiment of the present invention formed as a structure of a desk light is provided. A flicker flame bulb 30 is installed on the lamp holder 20 and can generate a gamboling, flickering and twinkling light beam inside the lampshade 10 when lighted. The lampshade 10 is settled around the lamp holder 20 and allows the light to be transmitted therethrough. One or more projection objects 40 designed with proper shapes may be settled in a space between the flicker flame bulb 30 and the lampshade 10 and one projection object 40 is implemented in the present embodiment. The projection object 40 may be made of an opaque material or a transparent and colored material, such as colored glass or transparent plastic. The lampshade 10 may have a monochromatic surface or may have patterns matching the shapes of the projection object 40 printed or painted thereon. Thereupon, when the flicker flame bulb 30 of the present invention is lighted, the gamboling and flickering light beam it provides can project the shape (and color as well) of the projection object 40 onto the surface of the lampshade 10 in a gamboling and flickering manner. When a viewer views the disclosed light from an outside thereof, it is observed that in addition to a limpid light source emitted from the lampshade 10, a projected image embodied from the projection object 40 is generated on the surface of the lampshade 10. No matter the projection object 40 is one or more, it can be projected to the lampshade 10 as a shadow (from the opaque material) or a transparent and colored image (from the transparent material) as vivid and animated images that are gamboling and moving, as shown in FIG. 3. Therefore, a novel and entertaining image with dynamic ornamental effects is formed on the surface of the lampshade 10 with functions of providing visual delight and contributing to festival atmosphere so as to remold the known form of the conventional lighting devices.

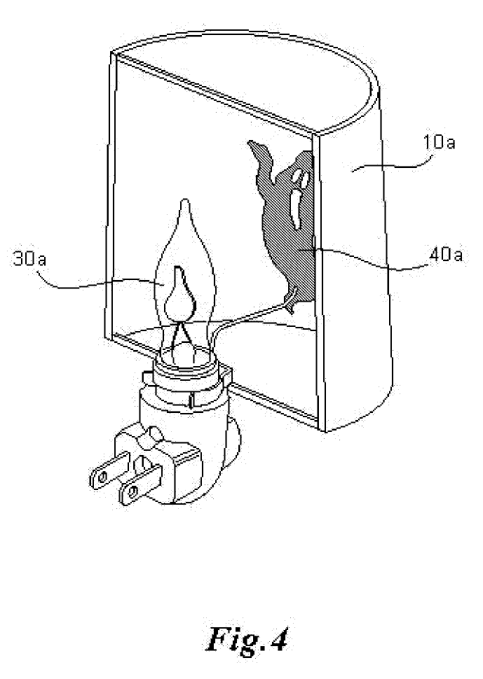

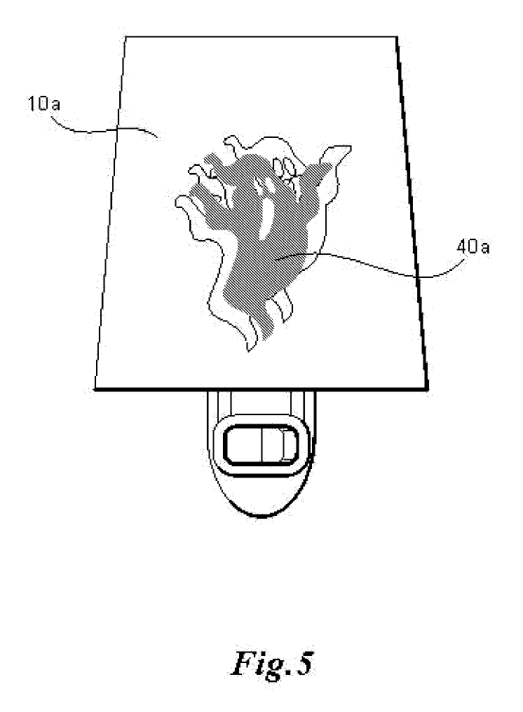

Referring to FIG. 4, the present invention is herein embodied as a wall lamp. In the present invention, a projection object 40a having a proper shape is also provided between the flicker flame bulb 30a and the lampshade 10a so that when the flicker flame bulb 30a is lighted to provide a gamboling and flickering light beam, the shape of the projection object 40a can be provided on a surface of the lampshade 10a dynamically, as shown in FIG. 5. While such wall lamp is typically installed aside a gate or in a porch as a night lighting source, the dynamic images presented on the lampshade 10a can especially bring surprising entertainment to an ordinary night time.

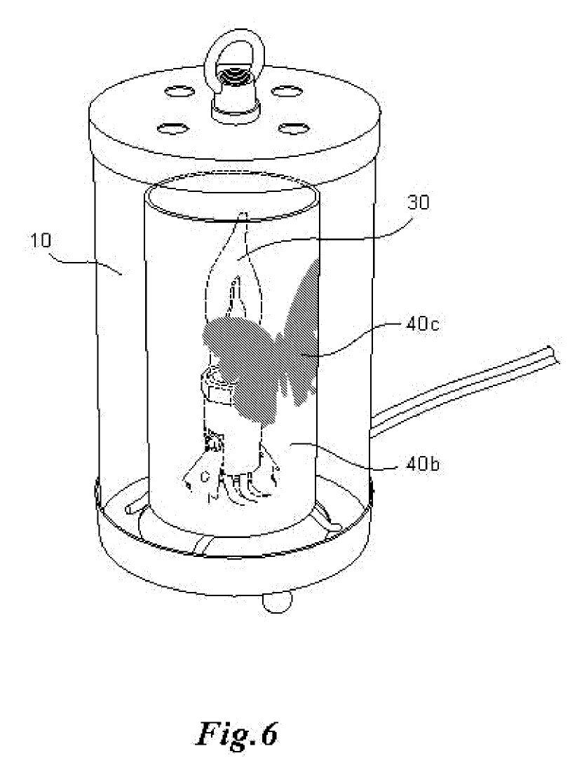

Furthermore, in addition to the above-mentioned structure, the projection object 40b of the present invention may be formed as a transparent or semitranslucent tube or planar or cambered sheet, wherein the projection object 40b in the form of a tube is as shown in FIG. 6. Proper patterns 40c may be printed onto a surface of the projection object 40b so that the alternative structure described herein is able to provide interesting dynamic ornamental effects as well. To sum up, the present invention implements a novel structure coming from elaborate design to settle the projection object having special shapes and transparent color in the space between the flicker flame bulb and the lampshade so that the shape of the projection object can be presented on the surface of the lampshade vividly and animatedly so as to provide unprecedented dynamic ornamental effects and therefore significantly improve the ornamental benefits and atmosphere-creating effects of the disclosed lighting device. As compared to the conventional lighting devices, the present invention is believed novel and advanced and therefore the present invention is submitted as a patent application.

What is claimed is:

1. An animated light with dynamic ornamental effects, comprising a lamp holder attached by a lampshade to form a basic structure, a flicker flame bulb installed on the lamp holder, and a projection object having a proper shape that is settled between the flicker flame bulb and the lampshade such that when the flicker flame bulb is lighted, the shape of the projection object can be projected to a surface of the lampshade in a dynamic form so as to present dynamic images.

2. The animated light of claim 1, wherein an amount of the projection object is one or more than one.

3. The animated light of claim 1, wherein the projection object is made of an opaque material or a transparent material having a plurality of colors.

4. The animated light of claim 1, wherein the projection object is formed as a tube or a sheet and has a pattern printed on a surface thereof.
